(19) United States
(12) Patent Application Publication
(10) Pub. No.: US 2014/0058796 A1
(43) Pub. Date: Feb. 27, 2014

(54) METHOD AND SYSTEM FOR PROVIDING PROXIMITY-BASED CROSS MARKETING AND PAYMENT ACTIVITY DATA

(71) Applicant: Jeffrey Mark Getchius, Cambridge, MA (US)

(72) Inventor: Jeffrey Mark Getchius, Cambridge, MA (US)

(73) Assignee: Verizon Patent and Licensing Inc., Basking Ridge, NJ (US)

(21) Appl. No.: 13/590,246

(22) Filed: Aug. 21, 2012

(51) Int. Cl. G06Q 30/02

(52) U.S. Cl. 705/7.34; 705/14.49

(57) ABSTRACT

An approach for providing proximity-based cross marketing and payment activity data is described. A purchase-related action of a user performed at a first store is tracked. A second store within proximity of the first store is determined based on the tracked purchase-related action. An offer relating to the second store is generated for the user in real-time with respect to the purchase-related action performed at the first store.

### BACKGROUND INFORMATION

Service providers are continually challenged to deliver value and convenience to consumers by providing compelling network services and advancing the underlying technologies. For example, service providers currently offer services and applications that provide users with recommendations of points of interest in a region based on the users' current location, as well as information with respect to those points of interest in the region. However, apart from mere interest, there are typically no additional incentives for the users to explore the points of interests. In addition, the region information is generally limited to basic data, such as phone numbers, hours of operations, the items and services offered, etc., which may not be sufficient for making informed economic decisions.

Therefore, there is a need for an approach to more effectively market to users, and to better enable users to make informed economic decisions.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of providing proximity-based cross marketing and payment activity data, according to an embodiment;

FIG. 2 is a diagram of the components of a marketing platform, according to an embodiment;

FIG. 3 is a flowchart of a process for providing proximity-based cross marketing, according to an embodiment;

FIG. 4 is a flowchart of a process for associating payment activities with stores and/or locations, according to an embodiment;

FIG. 5 is a flowchart of a process for generating maps depicting economic activity, according to an embodiment;

FIG. 6 is a diagram of scenarios for proximity-based cross marketing, according to an embodiment;

FIGS. 7A-7E are diagrams of heat-based maps reflecting payment activities, according to various embodiments;

FIG. 8 is a diagram of a computer system that can be used to implement various embodiments; and

FIG. 9 is a diagram of a chip set that can be used to implement an embodiment of the invention.

### DESCRIPTION OF THE PREFERRED EMBODIMENT

An apparatus, method, and software for providing proximity-based cross marketing and payment activity data are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

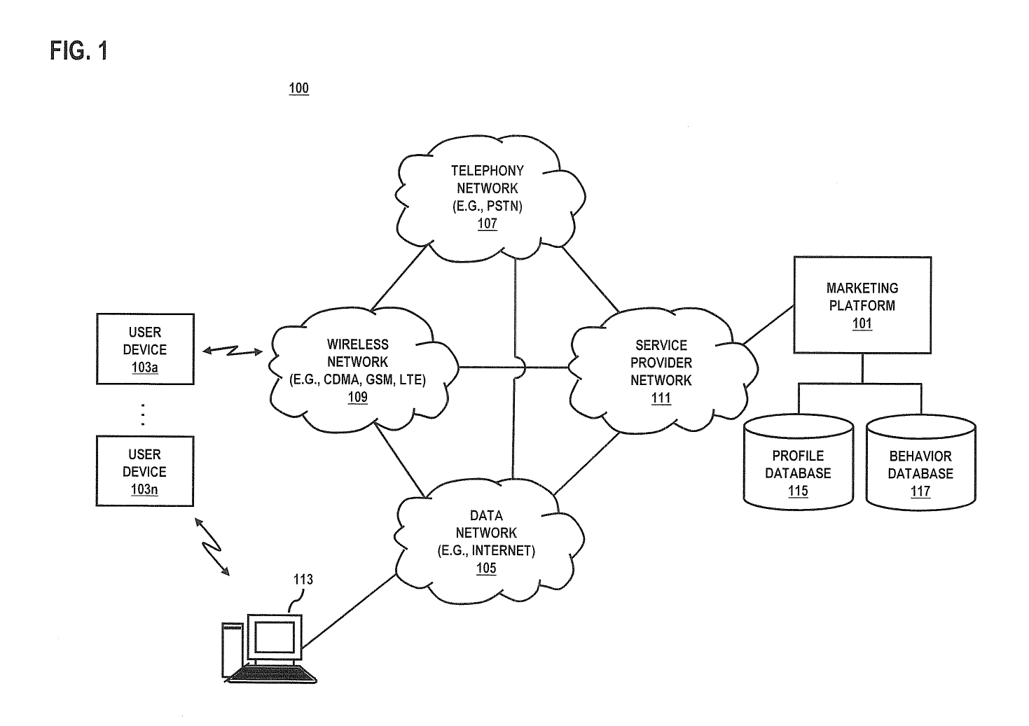

FIG. 1 is a diagram of a system capable of providing proximity-based cross marketing and payment activity data, according to an embodiment. For the purpose of illustration, the system 100 employs a marketing platform 101 that is configured to facilitate proximity-based cross marketing along with association of payment activities with locations and/or points of interest. One or more user devices 103 (or user devices 103a-103n) may, for instance, be utilized to access services related to marketing or payment activity data over one or more networks (e.g., data network 105, telephony network 107, wireless network 109, service provider network 111, etc.). According to one embodiment, these services may be included as part of managed services supplied by a service provider (e.g., a wireless communication company) as a hosted or a subscription-based service made available to users of the user devices 103 through the service provider network 111. Such services include tracking of user transactions to provide offers on products/services at nearby stores to users, for example, in real-time with respect to the tracked user transactions. Moreover, these services may include generation of information relating to payment activities in one or more areas. In this regard, marketing platform 101 may provide users with incentives to purchase or otherwise obtain the products/services, and assist users in making informed economic decisions (e.g., through presentation of the payment activities, recommendation of marketing approaches based on the payment activities, etc.).

As shown, the marketing platform 101 may be a part of or connected to the service provider network 111. According to another embodiment, the marketing platform 101 may be included within or connected to the user devices 103, a computing device 113, etc. In certain embodiments, the marketing platform 101 may include or have access to a profile database 115 and a behavior database 117. The profile database 115 may, for instance, be utilized to access or store user information (e.g., personal data, preferences, membership information, etc.), points of interest data (e.g., store profiles, store inventory data, etc.), or other profile-related data. In addition, the behavior database 117 may be utilized to access or store activity data, including, for example, purchase-related actions, payment activities, etc. While specific reference will be made thereto, it is contemplated that the system 100 may embody many forms and include multiple and/or alternative components and facilities.

As mentioned, services and applications provide users with recommendations of points of interests in a region based on the users' current location, along with information relating to those points of interests in the region. For example, a user who prefers a particular brand of shoes may be presented with stores that sell the particular shoe brand and that are currently near the user. Nonetheless, as discussed, there are generally no additional incentives (such as offers) to encourage those users to explore the points of interests. Moreover, the region information is typically limited to basic data, such as phone numbers, hours of operations, the items and services offered, etc. Such basic information, however, may not be sufficient when making various economic decisions, for instance, relating to advertising, new business or relocation opportunities, buying real estate, etc.

To address these issues, the system 100 of FIG. 1 provides the capability to facilitate proximity-based cross marketing. Specifically, the marketing platform 101 may track a purchase-related action of a user performed at a first store, and then determine a second store within proximity of the first store based on the tracked purchase-related action. Subsequently, the marketing platform 101 may also generate, in real-time with respect to the purchase-related action performed at the first store, an offer relating to the second store for the user. In another embodiment, the marketing platform 101 may also determine membership information, other purchase-related actions, or a combination thereof associated with the user, and the generated offer may be based on the membership information, the purchase-related action, the other purchase-related actions, or a combination thereof. As used herein, purchase-related actions may refer to actions that are typically associated with purchasing an item or service, such as scanning a price tag of the item or service, searching for the item or service online, browsing information associated with the item or service, checking out with the item or service in a shopping cart, etc.

By way of example, it may be determined that a user is currently inside of Store X (e.g., based on global positioning system (GPS) data before the user entered Store X, based on short-range wireless communication devices within Store X that detected the user's presence inside the store, etc.). While browsing items, the user may scan the price tag of a particular item with his/her mobile device to lookup product details corresponding to the item. As such, the price tag scan is tracked by the marketing platform 101 as having just occurred at Store X. In response, the marketing platform 101 may search for other stores within proximity of Store X based on the user's membership information (e.g., the type of cross-marketing service that the user has signed up for, the user's membership with nearby stores, etc.), the user's preferences (e.g., with respect to stores, products, services, etc.), relatedness of the scanned item to items and services offered by the other stores (e.g., complimentary items/services, similar items/services, etc.), other purchase-related actions associated with the user, alliances that Store X may have with the other stores, or other predetermined criteria. An offer relating to a nearby store that satisfies the predetermined criteria may then be generated in real-time with respect to the scanning of the price tag performed at Store X and, thereafter, presented to the user. In this way, the system 100 is able to provide more effective marketing by providing offers (e.g., advertisements, coupons, etc.) as additional incentives to explore other stores nearby, for example, in real-time while the user is still in the purchasing mood.

In addition, the system 100 of FIG. 1 may facilitate informed economic decisions by providing payment activity data. In another embodiment, for instance, the marketing platform 101 may determine payment activity relating to the purchase-related action. The marketing platform 101 may then associate the payment activity with the first store, a location of the first store, or a combination thereof. For example, in one use case, a user may electronically sign a contract at Store X that binds the user to pay mobile phone services for $100 per month for at least a one-year term. As a result, the signing of the contact by the user (as well as other related data) may then be associated with Store X and/or the location of Store X. Accordingly, the association of the payment activity (e.g., the signing of the contract by the user) with Store X (or its location) may be utilized to generate economic data, for example, with respect to a region relating to Store X for presentation to the user or other users to enable them to make sound economic decisions (e.g., where to advertise, when and where their business should be opened, where to purchase their home, where to be more cautious about fraudulent activities, etc.) through presentation of maps or other methods of representing the related data.

In another embodiment, the marketing platform 101 may generate a map depicting economic activity of a region based on the association. In further embodiments, the depiction of the economic activity may include a representation of consumers, businesses, payments, or a combination thereof, for example, that were involved in transactions occurring in the region. In one scenario, for instance, the map may be a heat map that indicates the locations of customers and merchants in a region along with a heat-based representation of overall payment activities (e.g., based on the association) that have occur in the region (e.g., within a certain period of time). In another scenario, the heat map may be presented to the user, and the user may have the option of modifying the heat map presentation. For example, the user may change the region for which economic activities should be depicted and the types of economic activities that are presented by selecting the desired region, the desired types of items/services, customers, businesses, etc., or the particular customers, business, groups, etc.

In another embodiment, the marketing platform 101 may determine density information associated with the payment activity and other payment activities, and the depiction of the economic activity may further be based on the density information. Density information may, for instance, include data indicating the density of the payment activity and the other payment activities with respect to time, location, number of occurrences, transaction value, etc. As an example, the density information may indicate density with respect to the number of payments that were made within particular areas of a region during a certain time period. In addition, in certain embodiments, the density may be presented using various colors, shadings, patterns, haptic feedbacks, sound effects, etc. Moreover, in other embodiments, the density information may also be utilized to represent the density of customers, businesses, etc., within particular areas of a region.

In another embodiment, the marketing platform 101 may determine a customer base, a potential customer base, or a combination thereof of the region based on the association, and the map may further depict the customer base, the potential customer base, or a combination thereof. By way of example, the payment activity (e.g., relating to the purchase-related action of the user) and the other payment activities (e.g., relating to other purchase-related actions of other users) may be processed to determine information about the users involved in those payment activities as well as information about the stores/locations at which those payment activities occurred. The user information and the store information may then be analyzed to determine the types of customers who have purchased items/services in the region along with the types of the potential customers of the region, for example, based on current trends, historical analysis, etc. Additionally, in some embodiments, the determination of the customer base and/or the potential customer base may be based on other factors, including density information associated with payment activities, forecasted market values, etc.

In another embodiment, the marketing platform 101 may forecast a market value relating to the location, other locations, or a combination thereof based on the association. In one use case, for instance, the association of the payment activity with the first store (or its location) as well as other associations of other payment activities with other stores (or their locations) may be processed to predict the market value of homes, businesses, etc., around the associated stores. Moreover, in certain embodiments, the forecasted value may be based on other factors, including density information associated with payment activities, current and potential customer bases, etc. For example, the marketing platform 101 may forecast a high market value for businesses in areas of a particular region that are determined to be substantially dense with respect to total transaction value (e.g., the overall revenue collected in those areas). Additionally, in other embodiments, the marketing platform 101 may predict and recommend advertising schedules/location, opening hours for businesses, locations for new businesses, areas to purchase homes, areas to avoid due to fraudulent activities, etc., based on association of payment activities with stores (or their locations), density information associated with payment activities, current and potential customer bases, forecasted values, etc.

It is noted that the marketing platform 101, the user devices 103, the computing device 113, and other elements of the system 100 may be configured to communicate via the service provider network 111. According to certain embodiments, one or more networks, such as the data network 105, the telephony network 107, and/or the wireless network 109, may interact with the service provider network 111. The networks 105-111 may be any suitable wireline and/or wireless network, and be managed by one or more service providers. For example, the data network 105 may be any local area network (LAN), metropolitan area network (MAN), wide area network (WAN), the Internet, or any other suitable packet-switched network, such as a commercially owned, proprietary packet-switched network, such as a proprietary cable or fiber-optic network. The telephony network 107 may include a circuit-switched network, such as the public switched telephone network (PSTN), an integrated services digital network (ISDN), a private branch exchange (PBX), or other like network. Meanwhile, the wireless network 109 may employ various technologies including, for example, code division multiple access (CDMA), long term evolution (LTE), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like.

Although depicted as separate entities, the networks 105-111 may be completely or partially contained within one another, or may embody one or more of the aforementioned infrastructures. For instance, the service provider network 111 may embody circuit-switched and/or packet-switched networks that include facilities to provide for transport of circuit-switched and/or packet-based communications. It is further contemplated that the networks 105-111 may include components and facilities to provide for signaling and/or bearer communications between the various components or facilities of the system 100. In this manner, the networks 105-111 may embody or include portions of a signaling system 7 (SS7) network, Internet protocol multimedia subsystem (IMS), or other suitable infrastructure to support control and signaling functions.

Further, it is noted that the user devices 103 may be any type of mobile or computing terminal including a mobile handset, mobile station, mobile unit, multimedia computer, multimedia tablet, communicator, netbook, Personal Digital Assistants (PDAs), smartphone, media receiver, personal computer, workstation computer, set-top box (STB), digital video recorder (DVR), television, automobile, appliance, etc. It is also contemplated that the user devices 103 may support any type of interface for supporting the presentment or exchange of data. In addition, user devices 103 may facilitate various input means for receiving and generating information, including touch screen capability, keyboard and keypad data entry, voice-based input mechanisms, accelerometer (e.g., shaking the user device 103), and the like. Any known and future implementations of user devices 103 are applicable. It is noted that, in certain embodiments, the user devices 103 may be configured to establish peer-to-peer communication sessions with each other using a variety of technologies—i.e., near field communication (NFC), Bluetooth, infrared, etc. Also, connectivity may be provided via a wireless local area network (LAN). By way of example, a group of user devices 103 may be configured to a common LAN so that each device can be uniquely identified via any suitable network addressing scheme. For example, the LAN may utilize the dynamic host configuration protocol (DHCP) to dynamically assign “private” DHCP internet protocol (IP) addresses to each user device 103, i.e., IP addresses that are accessible to devices connected to the service provider network 111 as facilitated via a router.

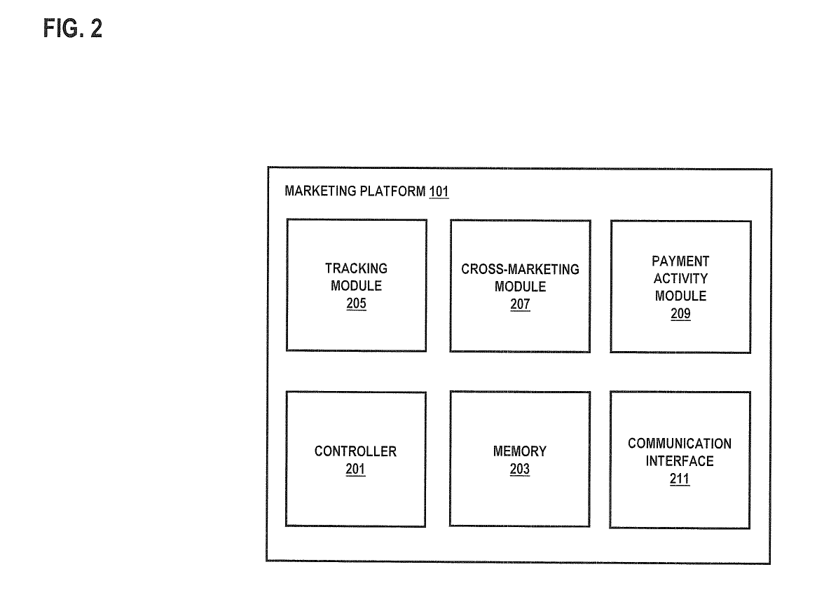

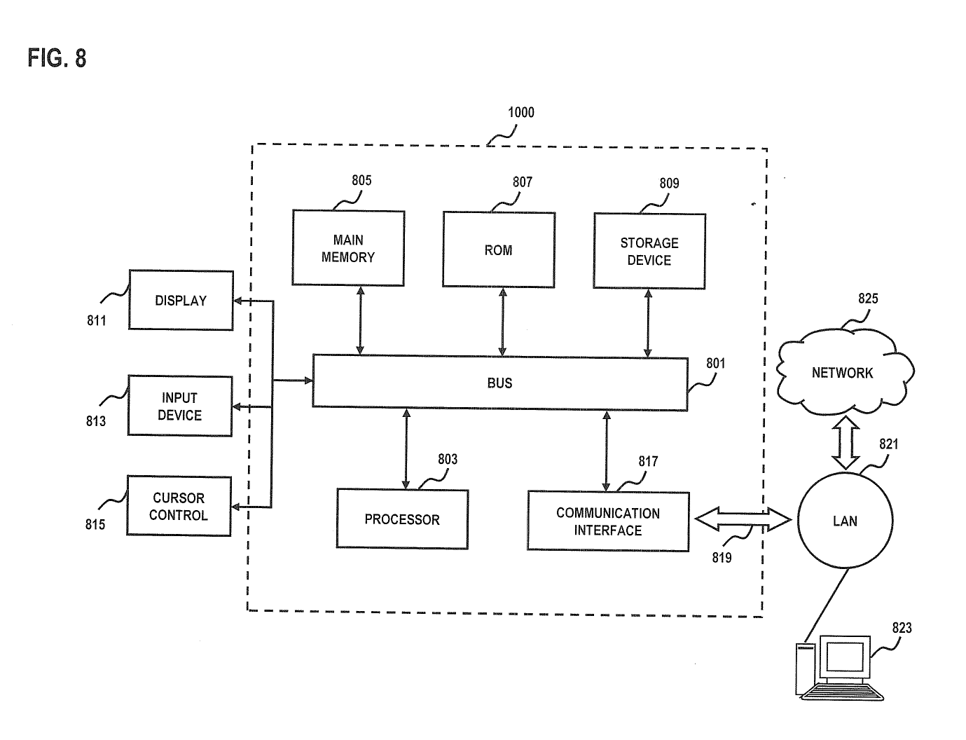

FIG. 2 is a diagram of the components of a marketing platform, according to an embodiment. The marketing platform 101 may comprise computing hardware (such as described with respect to FIG. 8), as well as include one or more components configured to execute the processes described herein for providing proximity-based cross marketing and payment activity data. It is contemplated that the functions of these components may be combined in one or more components or performed by other components of equivalent functionality. In certain embodiments, the marketing platform 101 includes a controller (or processor) 201, memory 203, a tracking module 205, a cross-marketing module 207, a payment activity module 209, and a communication interface 211.

The controller 201 may execute at least one algorithm for executing functions of the marketing platform 101. For example, the controller 201 may work with the tracking module 205 to track a purchase-related action of a user performed at a first store. As indicated, purchase-related actions may refer to actions that are typically associated with purchasing an item or service, such as scanning a price tag of the item or service, searching for the item or service online, browsing information associated with the item or service, checking out with the item or service in a shopping cart, etc. In one use case, for instance, the tracking module 205 may analyze GPS data to determine the last detected location of the user's mobile device before the GPS signal was lost (e.g., signifying that the user is at a store located at the last detected location). Additionally, or alternatively, the tracking module 205 may utilize short-range wireless communication devices within the first store to interact with the user's mobile device (e.g., using WiFi, Bluetooth, near field communication (NFC), etc.) to determine that the user is inside the first store. The tracking module 205 may also monitor the activities of the user via the mobile device, cameras within the first store, etc., to determine when the user is performing a purchase-related action at the first store.

In response to a determination by the tracking module 205 that the user has performed a purchase-related action at the first store, the cross-marketing module 207 may determine a second store within proximity of the first store. As discussed, the determination of the second store may be based on several other factors in addition to the proximity to the first store. If, for instance, the purchase-related action is associated with an particular item, the second store may be determined by searching other stores within proximity of the first store based on the user's membership information (e.g., the type of cross-marketing service that the user has signed up for, the user's membership with nearby stores, etc.), the user's preferences (e.g., with respect to stores, products, services, etc.), relatedness of the particular item to items and services offered by the other stores (e.g., complimentary items/services, similar items/services, etc.), other purchase-related actions associated with the user, alliances that the first store may have with the other stores, or other factors.

The cross-marketing module 207 may then also generate, in real-time with respect to the purchase-related action performed at the first store, an offer relating to the second store for the user. In certain embodiments, the generated offer may be based on membership information, the purchase-related action and/or other purchase-related actions associated with the user. By way of example, if the user has a membership with the second store, the user's membership information may include loyalty information (e.g., indications that the user is a frequent purchaser, data regarding rewards earned from past purchases, etc.) and discount information (e.g., membership coupons, rewards, etc.) associated with the user and the second store. As such, in one use case, the generated offer may include a depiction of one or more items offered at the second store along with the final price of those items after the loyalty information and the discount information have been considered.

In some embodiments, the controller 201 may also direct the payment activity module 209 to determine payment activity relating to the purchase-related action, and to associate the payment activity with the first store, a location of the first store, etc. In one embodiment, the association of the payment activity with the first store (or its location) may then be utilized to generate a map depicting economic activity of a region. In another embodiment, the economic activity may include a representation of consumers, businesses, and/or payments, for example, that were involved in transactions occurring in the region.

In various embodiments, the payment activity module 209 may determine density information associated with the payment activity and other payment activities, and the depiction of the economic activity may be based on the density information. As indicated, density information may include data indicating the density of the payment activity and the other payment activities with respect to time, location, number of occurrences, transaction value, etc. As an example, the density information may indicate density with respect to the number of payments that were made within particular areas of a region during a certain time period. Moreover, in one embodiment, the density may be presented using various colors, shadings, patterns, haptic feedbacks, sound effects, etc.

In other embodiments, the payment activity module 209 may determine a customer base and/or a potential customer base of the region based on the association, density information associated with payment activities, and/or forecasted market values, and the map may also depict the customer base and/or the potential customer base. In one embodiment, the payment activity module 209 may forecast a market value relating to the location and/or other locations based on the association, density information associated with payment activities, and/or current and potential customer bases. In another embodiment, the payment activity module 209 may predict and recommend advertising schedules/location, opening hours for businesses, locations for new businesses, areas to purchase homes, areas to avoid due to fraudulent activities, etc., based on association of payment activities with stores (or their locations), density information associated with payment activities, current and potential customer bases, and/or forecasted values.

Furthermore, the controller 201 may utilize the communication interface 211 to communicate with other components of the marketing platform 101, the user devices 103, and other components of the system 100. The communication interface 211 may include multiple means of communication. For example, the communication interface 211 may be able to communicate over short message service (SMS), multimedia messaging service (MMS), internet protocol, instant messaging, voice sessions (e.g., via a phone network), email, or other types of communication.

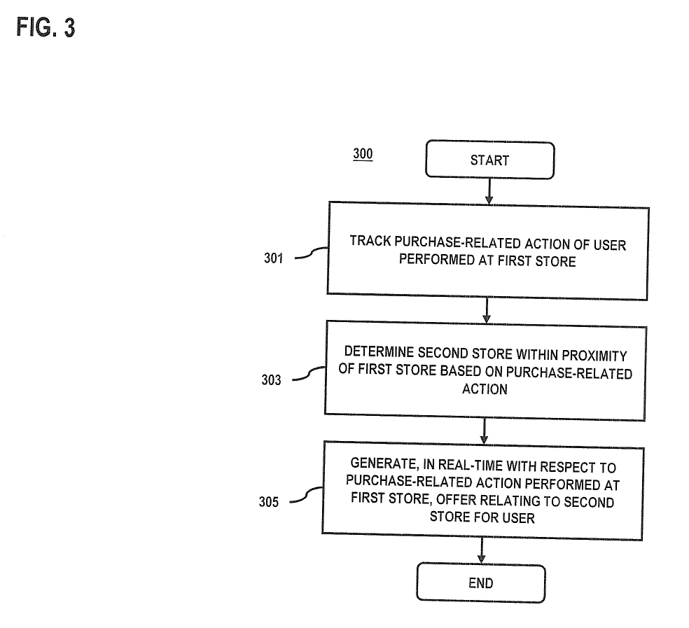

FIG. 3 is a flowchart of a process for providing proximity-based cross marketing, according to an embodiment. For the purpose of illustration, process 300 is described with respect to FIG. 1. It is noted that the steps of the process 300 may be performed in any suitable order, as well as combined or separated in any suitable manner. In step 301, the marketing platform 101 may track a purchase-related action of a user performed at a first store. As indicated, purchase-related actions may refer to actions that are typically associated with purchasing an item or service, such as scanning a price tag of the item or service, searching for the item or service online, browsing information associated with the item or service, checking out with the item or service in a shopping cart, etc. In certain embodiments, for instance, tracking of purchase-related actions at a store may be performed by determining that a user is inside of the store using GPS data (e.g., the last detected location of the user's mobile device) or other detection techniques (e.g., based on WiFi, Bluetooth, NFC, etc.), and then monitoring the activities of the user via the user's mobile device, cameras within the store, etc.

In step 303, the marketing platform 101 may determine a second store within proximity of the first store based on the tracked purchase-related action. As discussed, the determination of the second store may be based on several other factors in addition to the proximity to the first store. If, for instance, the purchase-related action is associated with an particular item, the second store may be determined by searching other stores within proximity of the first store based on the user's membership information (e.g., the type of cross-marketing service that the user has signed up for, the user's membership with nearby stores, etc.), the user's preferences (e.g., with respect to stores, products, services, etc.), relatedness of the particular item to items and services offered by the other stores (e.g., complimentary items/services, similar items/services, etc.), other purchase-related actions associated with the user, alliances that the first store may have with the other stores, or other factors.

In step 305, the marketing platform 101 may generate, in real-time with respect to the purchase-related action performed at the first store, an offer relating to the second store for the user. In some embodiments, the marketing platform 101 may also determine membership information, other purchase-related actions, or a combination thereof associated with the user, and the offer may be based on the membership information, the purchase-related action, the other purchase-related actions, or a combination thereof. By way of example, if the user has a membership with the second store, the user's membership information may include loyalty information (e.g., indications that the user is a frequent purchaser, data regarding rewards earned from past purchases, etc.) and discount information (e.g., membership coupons, rewards, etc.) associated with the user and the second store. As such, in one use case, the generated offer may include a depiction of one or more items offered at the second store along with the final price of those items after the loyalty information and the discount information have been considered.

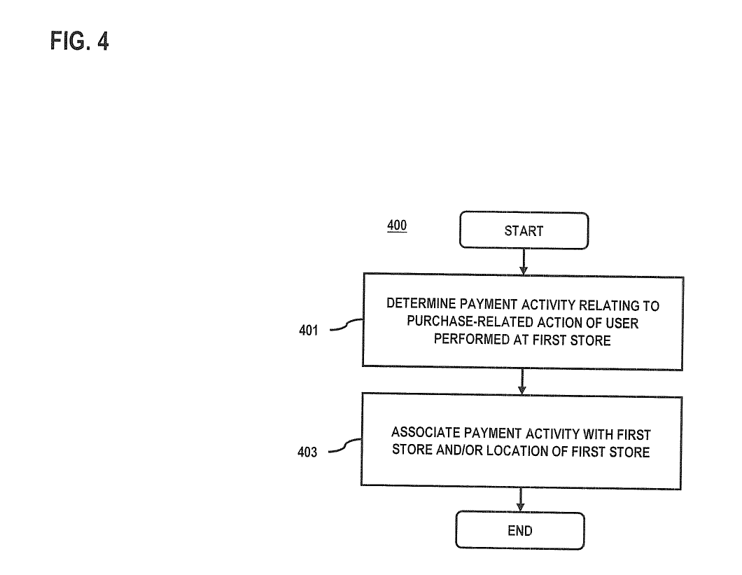

FIG. 4 is a flowchart of a process for associating payment activities with stores and/or locations, according to an embodiment. For the purpose of illustration, process 400 is described with respect to FIG. 1. It is noted that the steps of the process 400 may be performed in any suitable order, as well as combined or separated in any suitable manner. In step 401, the marketing platform 101 may determine payment activity relating to the purchase-related action of the user performed at the first store. The marketing platform 101 may then, at step 403, associate the payment activity with the first store, a location of the first store, or a combination thereof.

By way of example, the marketing platform 101 may track one or more purchase-related actions of a user as the user is shopping at Store X. When the user is at the register to purchase an item, payment activity relating to the item purchase may be determined and corresponding data may be stored. The corresponding data may, for instance, specify the transaction value of the purchase, the time of the payment, the type of payment (e.g., cash, check, credit card, mobile payment, etc.), identification of the user who made the payment, the location/store at which the payment was made, etc. Such corresponding data may then be associated with Store X (or its location), where the association may then be utilized for a number of purposes. As indicated, for instance, the data relating to associations of payment activities with stores/locations may be utilized to enable users to make informed economic decisions (e.g., where to advertise, when and where their business should be opened, where to purchase their home, where to be more cautious about fraudulent activities, etc.) through presentation of maps or other methods of representing the related data. In addition, in some embodiments, the marketing platform 101 may process such associations to predict and recommend advertising schedules/location, opening hours for businesses, locations for new businesses, areas to purchase homes, areas to avoid due to fraudulent activities, etc., based on association of payment activities with stores (or their locations), density information associated with payment activities, current and potential customer bases, forecasted values, etc.

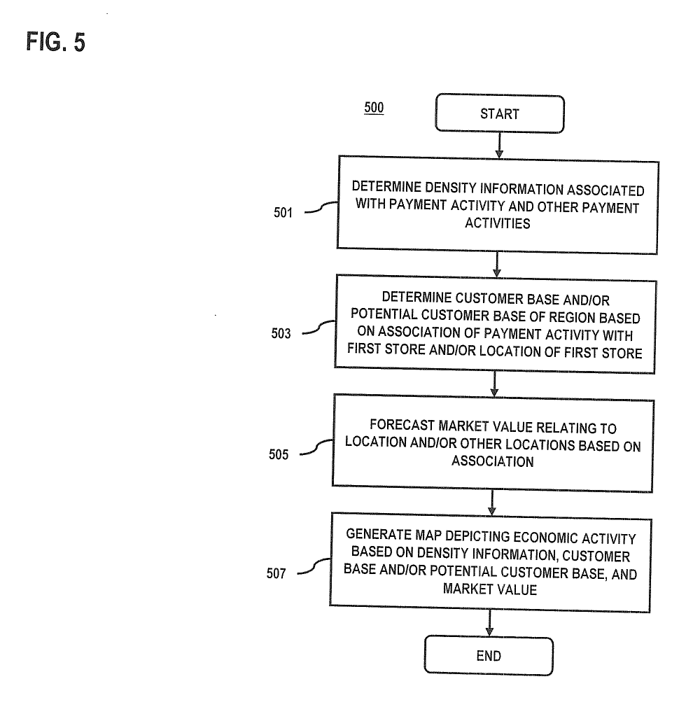

FIG. 5 is a flowchart of a process for generating maps depicting economic activity, according to an embodiment. For the purpose of illustration, process 500 is described with respect to FIG. 1. It is noted that the steps of the process 500 may be performed in any suitable order, as well as combined or separated in any suitable manner. In step 501, the marketing platform 101 may determine density information associated with the payment activity and other payment activities. As discussed, density information may include data indicating the density of the payment activity and the other payment activities with respect to time, location, number of occurrences, transaction value, etc. As an example, the density information may indicate density with respect to the number of payments that were made within particular areas of a region during a certain time period. Moreover, in one embodiment, the density may be presented using various colors, shadings, patterns, haptic feedbacks, sound effects, etc.

In step 503, the marketing platform 101 may determine a customer base, a potential customer base, or a combination thereof of the region based on the association of the payment activity with the first store and/or a location of the first store. In one scenario, for instance, the payment activity (e.g., relating to the purchase-related action of the user) and the other payment activities (e.g., relating to other purchase-related actions of other users) may be processed to determine information about the users involved in those payment activities as well as information about the stores/locations at which those payment activities occurred. The user information and the store information may then be analyzed to determine the types of customers that have purchased items/services in the region along with the potential customers of the region, for example, based on current trends, historical analysis, etc. Additionally, in some embodiments, the determination of the customer base, the potential customer base, or a combination thereof may also be based on other factors, including density information associated with payment activities, forecasted market values, etc.

In step 505, the marketing platform 101 may forecast a market value relating to the location, other locations, or a combination thereof based on the association. By way of example, the association of the payment activity with the first store (or its location) as well as other associations of other payment activities with other stores (or their locations) may be processed to predict the market value of homes, businesses, etc., around the associated stores. Further, in certain embodiments, the forecasted value may be based on other factors, including density information associated with payment activities, current and potential customer bases, etc.

In step 507, the marketing platform 101 may generate a map depicting economic activity of a region based on the density information, the customer base and/or the potential customer base, and the market value. As indicated, in some embodiments, the map may be a heat map that depicts the density of payment activities (e.g., with respect to time, location, number of occurrences, transaction value, etc.) using various colors, shadings, patterns, haptic feedbacks, sound effects, etc., over certain areas representing the region. In other embodiments, various icons may be utilized to illustrate the density of the payment activities, the customer base and/or the potential customer base, and the market value.

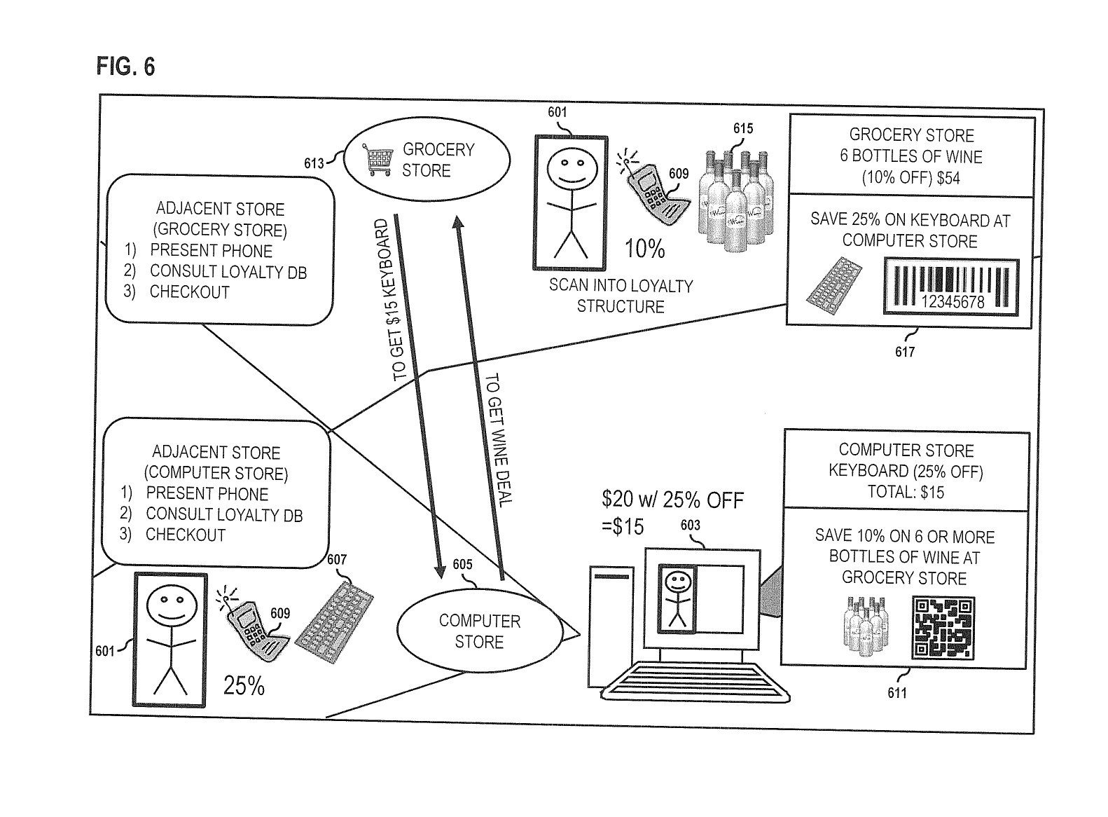

FIG. 6 is a diagram of scenarios for proximity-based cross marketing, according to an embodiment. For example, in one scenario, when a user 601 walks over to a register 603 in a store 605 to check out a keyboard 607, the register 603 may present the cashier with membership information corresponding to the user 601 (e.g., a picture of the user 601 along with the user's membership information accessed from the profile database 115 using identity information from the user's mobile phone 609). As such, the cashier is better prepared to effectively assist the user 601 since the cashier has identified the user 601 in advance and the cashier already has the user's membership information (e.g., including loyalty information and discount information). As the user 601 checks out the keyboard 607, the purchase-related action (e.g., checking out the keyboard 607) is detected, triggering the generation of an offer 611 for wine at a nearby store 613. The offer 611 may, for instance, be automatically added to the user account of user 601, or presented at the register 603 for scanning by the mobile device 609 to add the offer 611 to the user account. Moreover, as shown, the user 601 is given a 25% discount off the keyboard 609 as a result of a previous offer stored on the user account (e.g., from a previous visit at store 613 or another nearby store).

In another scenario, when the user 601 walks over to a register in the store 613 to check out several bottles of wine 615, the register may present the cashier with membership information corresponding to the user 601 to enable the cashier to better assist the user 601. In addition, as the user 601 checks out the bottles of wine 615, the purchase-related action (e.g., checking out the bottles of wine 615) is detected, triggering the generation of an offer 617 for keyboards at the nearby store 605. As indicated, the offer 617 may be automatically added to the user account of user 601, or presented at the register for scanning by the mobile device 609 to add the offer 617 to the user account. Further, as depicted, the user 601 is given a 10% discount off the bottles of wine as a result of a previous offer stored on the user account (e.g., from a previous visit at store 611 or another nearby store).

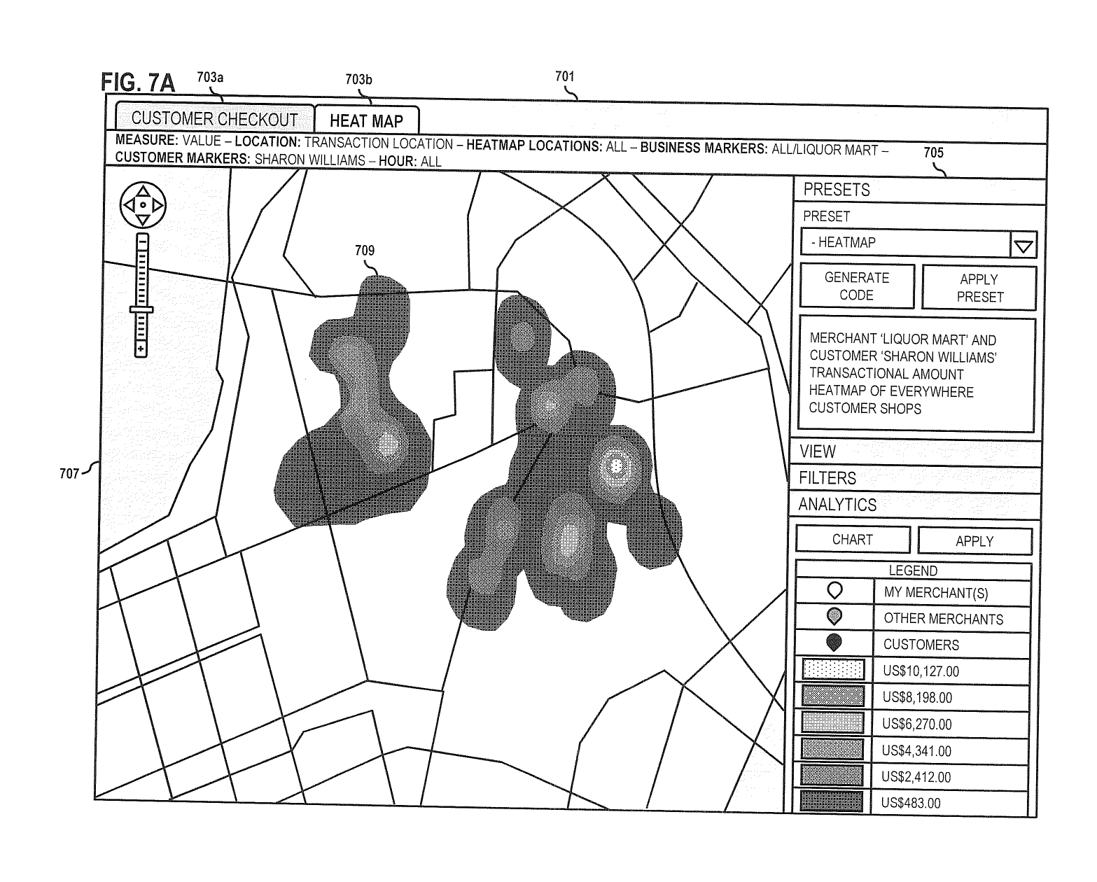

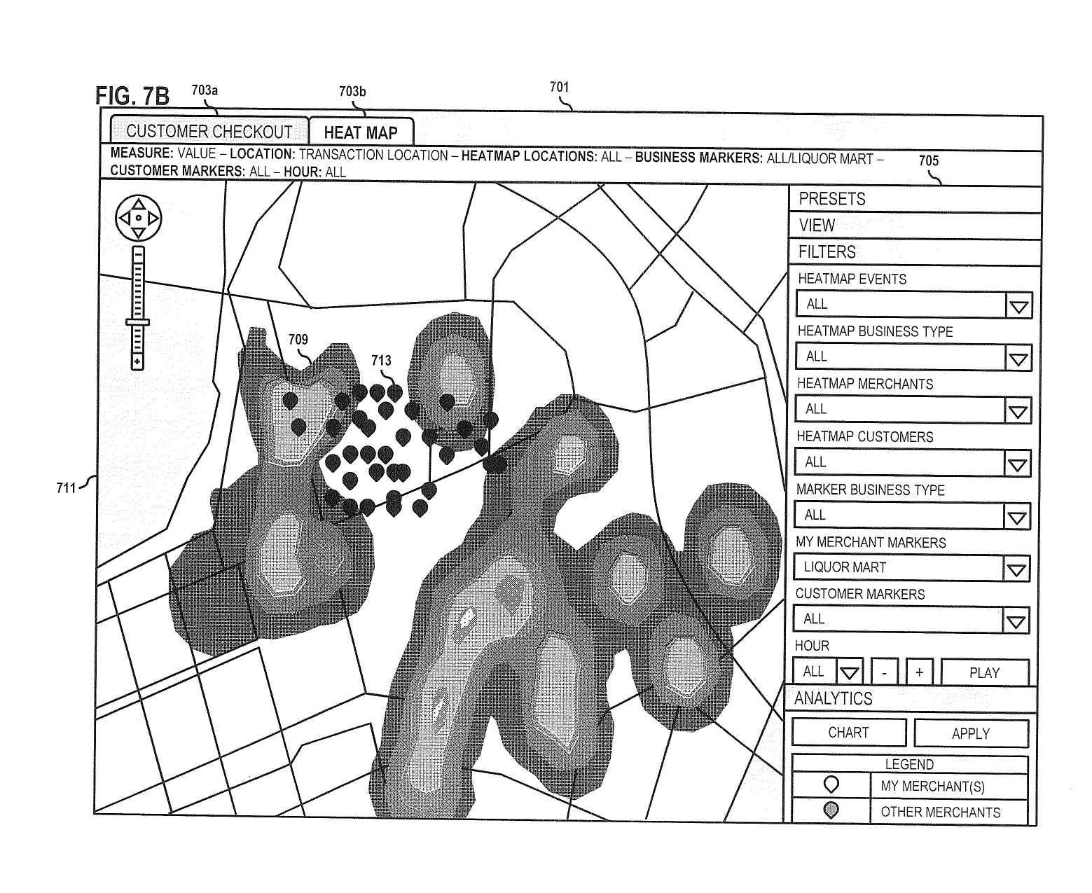

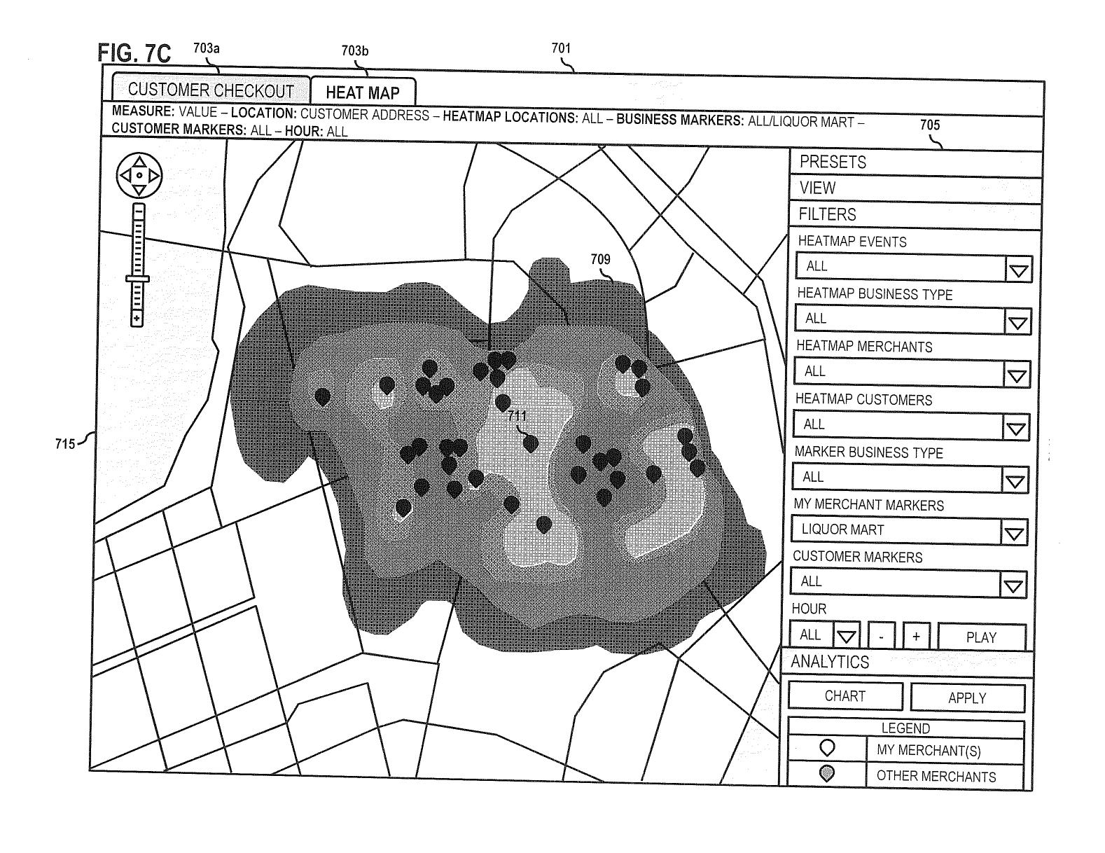

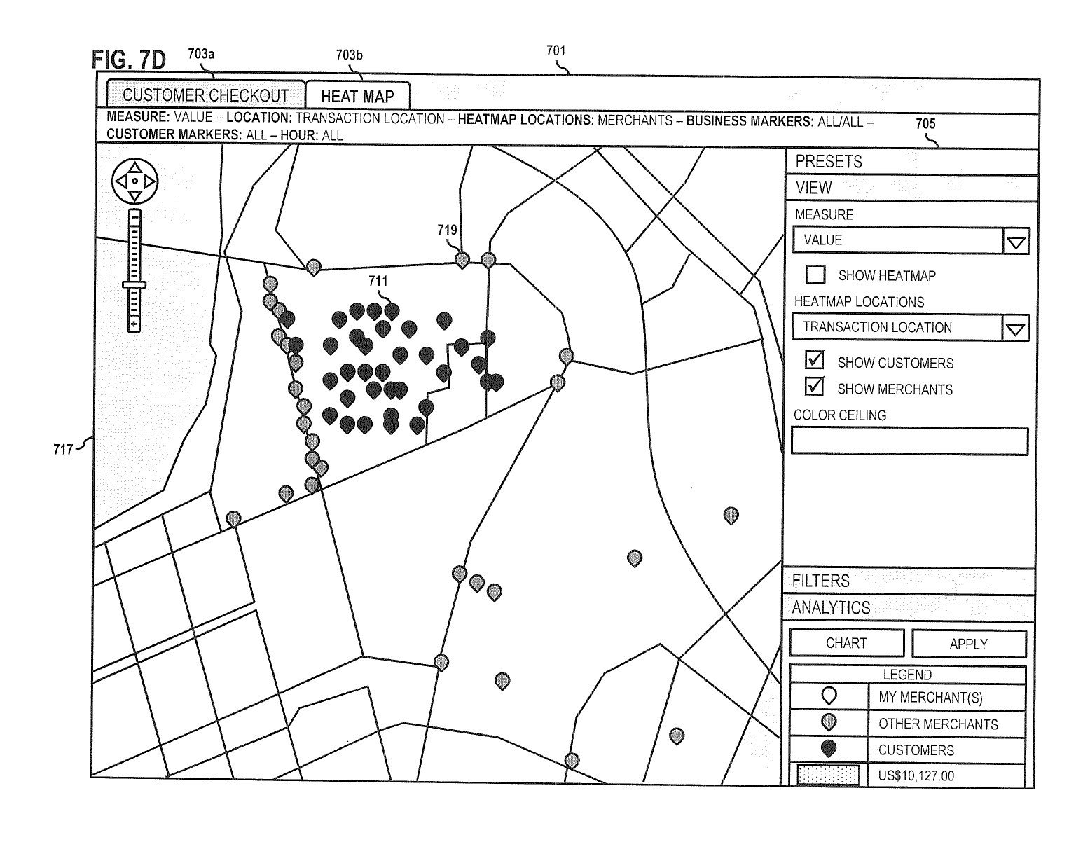

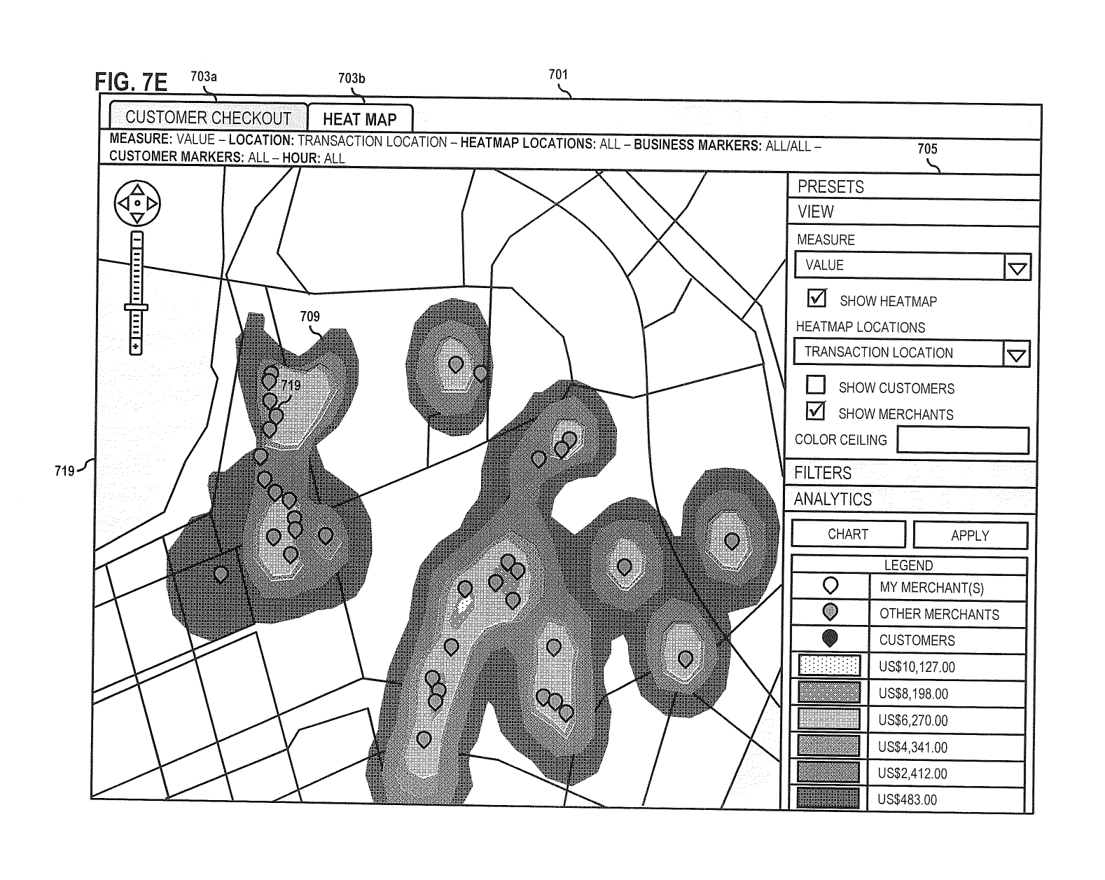

FIGS. 7A-7E are diagrams of heat-based maps reflecting payment activities, according to various embodiments. For example, FIG. 7A illustrates a user interface 701 with tabs 703, information/options section 705, and a map 707. As shown, the map 707 depicts economic activity pertaining to a particular region through several layers 709 representing the density of payments in different areas of the region using various colors, shadings, patterns, etc. In this scenario, the economic activity focuses on payments with respect to liquor business transactions in the region by a single customer (e.g., Sharon Williams). The user interface 701 may, for instance, enable to the customer (or businesses) to see how much she has spent on liquor business transactions in various areas of the region.

FIG. 7B illustrates the user interface 701 featuring a map 711 depicts payment activity with respect to liquor business transactions in a region by numerous customers (e.g., represented by customer indicators 713). As shown, the map 711 depicts the payment activity of the region through the layers 709 representing the density of those payments in different areas of the region using various colors, shadings, patterns, etc. The user interface 701 may, for instance, enable users (e.g., customers, businesses, etc.) to see where customers involved with liquor business transactions occurring in the region are located along with where those transactions occur and the extent of those transactions. As illustrated, density information, payment activity data, etc., may be anonymized to prevent others from accessing and obtaining personal customer information.

FIG. 7C illustrates the user interface 701 featuring a map 715 depicting payment activity with respect to liquor business transactions in a region by numerous customers (e.g., represented by customer indicators 713) using density layers 709. As shown, in this scenario, the user interface 701 focuses the map 715 based on the customer addresses, for example, to obtain a better view of payment activities that occur around the customer locations (e.g., residential, business, etc.). FIG. 7D illustrates the user interface 701 featuring a map 717 depicting locations of customers (e.g., represented by customer indicators 713) and merchants (e.g., represented by merchant indicators 719) in a region with a focus on transaction and merchant locations. FIG. 7E illustrates the user interface 701 featuring a map 717 depicting payment activity with respect to all transactions in a region using density layers 709. As shown, the map 717 may also feature various merchants (e.g., represented by merchant indicators 719), for example, that are partners, users, etc., of a service associated with the user interface 701.

The processes described herein for providing proximity-based cross marketing and payment activity data may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

FIG. 8 is a diagram of a computer system that can be used to implement various embodiments. The computer system 800 includes a bus 801 or other communication mechanism for communicating information and one or more processors (of which one is shown) 803 coupled to the bus 801 for processing information. The computer system 800 also includes main memory 805, such as a random access memory (RAM) or other dynamic storage device, coupled to the bus 801 for storing information and instructions to be executed by the processor 803. Main memory 805 can also be used for storing temporary variables or other intermediate information during execution of instructions by the processor 803. The computer system 800 may further include a read only memory (ROM) 807 or other static storage device coupled to the bus 801 for storing static information and instructions for the processor 803. A storage device 809, such as a magnetic disk, flash storage, or optical disk, is coupled to the bus 801 for persistently storing information and instructions.

The computer system 800 may be coupled via the bus 801 to a display 811, such as a cathode ray tube (CRT), liquid crystal display, active matrix display, or plasma display, for displaying information to a computer user. Additional output mechanisms may include haptics, audio, video, etc. An input device 813, such as a keyboard including alphanumeric and other keys, is coupled to the bus 801 for communicating information and command selections to the processor 803. Another type of user input device is a cursor control 815, such as a mouse, a trackball, touch screen, or cursor direction keys, for communicating direction information and command selections to the processor 803 and for adjusting cursor movement on the display 811.

According to an embodiment of the invention, the processes described herein are performed by the computer system 800, in response to the processor 803 executing an arrangement of instructions contained in main memory 805. Such instructions can be read into main memory 805 from another computer-readable medium, such as the storage device 809. Execution of the arrangement of instructions contained in main memory 805 causes the processor 803 to perform the process steps described herein. One or more processors in a multi-processing arrangement may also be employed to execute the instructions contained in main memory 805. In alternative embodiments, hard-wired circuitry may be used in place of or in combination with software instructions to implement the embodiment of the invention. Thus, embodiments of the invention are not limited to any specific combination of hardware circuitry and software.

The computer system 800 also includes a communication interface 817 coupled to bus 801. The communication interface 817 provides a two-way data communication coupling to a network link 819 connected to a local network 821. For example, the communication interface 817 may be a digital subscriber line (DSL) card or modem, an integrated services digital network (ISDN) card, a cable modem, a telephone modem, or any other communication interface to provide a data communication connection to a corresponding type of communication line. As another example, communication interface 817 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 817 sends and receives electrical, electromagnetic, or optical signals that carry digital data streams representing various types of information. Further, the communication interface 817 can include peripheral interface devices, such as a Universal Serial Bus (USB) interface, a PCMCIA (Personal Computer Memory Card International Association) interface, etc. Although a single communication interface 817 is depicted in FIG. 8, multiple communication interfaces can also be employed.

The network link 819 typically provides data communication through one or more networks to other data devices. For example, the network link 819 may provide a connection through local network 821 to a host computer 823, which has connectivity to a network 825 (e.g. a wide area network (WAN) or the global packet data communication network now commonly referred to as the “Internet”) or to data equipment operated by a service provider. The local network 821 and the network 825 both use electrical, electromagnetic, or optical signals to convey information and instructions. The signals through the various networks and the signals on the network link 819 and through the communication interface 817, which communicate digital data with the computer system 800, are exemplary forms of carrier waves bearing the information and instructions.

The computer system 800 can send messages and receive data, including program code, through the network(s), the network link 819, and the communication interface 817. In the Internet example, a server (not shown) might transmit requested code belonging to an application program for implementing an embodiment of the invention through the network 825, the local network 821 and the communication interface 817. The processor 803 may execute the transmitted code while being received and/or store the code in the storage device 809, or other non-volatile storage for later execution. In this manner, the computer system 800 may obtain application code in the form of a carrier wave.

The term “computer-readable medium” as used herein refers to any medium that participates in providing instructions to the processor 803 for execution. Such a medium may take many forms, including but not limited to computer-readable storage medium ((or non-transitory)—i.e., non-volatile media and volatile media), and transmission media. Non-volatile media include, for example, optical or magnetic disks, such as the storage device 809. Volatile media include dynamic memory, such as main memory 805. Transmission media include coaxial cables, copper wire and fiber optics, including the wires that comprise the bus 801. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

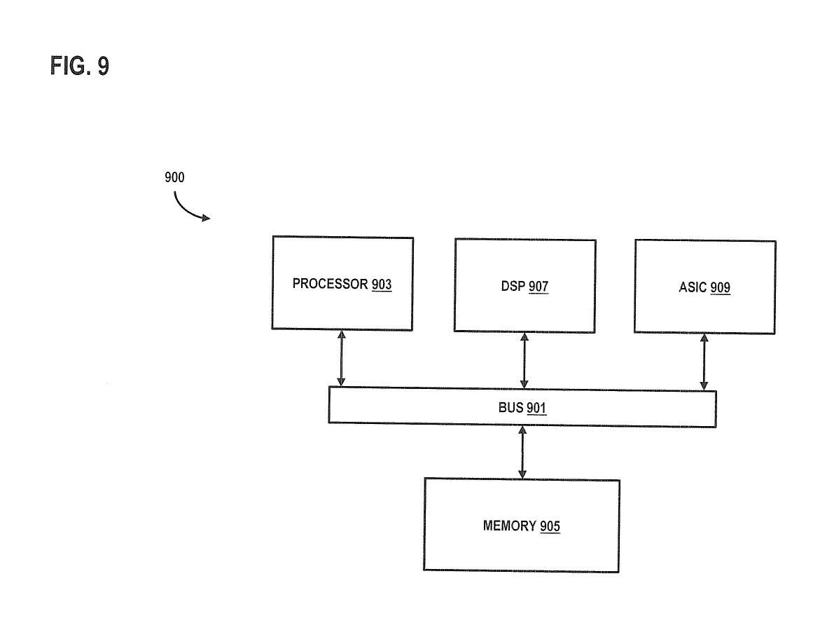

FIG. 9 illustrates a chip set or chip 900 upon which an embodiment of the invention may be implemented. Chip set 900 is programmed to enable proximity-based cross marketing and analysis using payment activity data as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of enabling proximity-based cross marketing and analysis using payment activity data.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to enable proximity-based cross marketing and analysis using payment activity data. The memory 905 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
tracking a purchase-related action of a user performed at a first store;
determining a second store within proximity of the first store based on the tracked purchase-related action; and
generating, in real-time with respect to the purchase-related action performed at the first store, an offer relating to the second store for the user.

2. A method according to claim 1, further comprising:
determining membership information, other purchase-related actions, or a combination thereof associated with the user, wherein the offer is based on the membership information, the purchase-related action, the other purchase-related actions, or a combination thereof.

3. A method according to claim 1, further comprising:
determining payment activity relating to the purchase-related action; and
associating the payment activity with the first store, a location of the first store, or a combination thereof.

4. A method according to claim 3, further comprising:
generating a map depicting economic activity of a region based on the association.

5. A method according to claim 4, wherein the depiction of the economic activity includes a representation of consumers, businesses, payments, or a combination thereof.

6. A method according to claim 4, further comprising:
determining density information associated with the payment activity and other payment activities, wherein the depiction of the economic activity is further based on the density information.

7. A method according to claim 4, further comprising:
determining a customer base, a potential customer base, or a combination thereof of the region based on the association, wherein the map further depicts the customer base, the potential customer base, or a combination thereof.

8. A method according to claim 3, further comprising:
forecasting a market value relating to the location, other locations, or a combination thereof based on the association.

9. An apparatus comprising:
at least one processor; and
at least one memory including computer program code for one or more programs,
the at least one memory and the computer program code configured to, with the at least one processor, cause the apparatus to perform at least the following,
track a purchase-related action of a user performed at a first store;
determine a second store within proximity of the first store based on the tracked purchase-related action; and
generate, in real-time with respect to the purchase-related action performed at the first store, an offer relating to the second store for the user.

10. An apparatus according to claim 9, wherein the apparatus is further caused to:
determine membership information, other purchase-related actions, or a combination thereof associated with the user, wherein the offer is based on the membership information, the purchase-related action, the other purchase-related actions, or a combination thereof.

11. An apparatus according to claim 9, wherein the apparatus is further caused to:
determine payment activity relating to the purchase-related action; and
associate the payment activity with the first store, a location of the first store, or a combination thereof.

12. An apparatus according to claim 11, wherein the apparatus is further caused to:
generate a map depicting economic activity of a region based on the association.

13. An apparatus according to claim 12, wherein the depiction of the economic activity includes a representation of consumers, businesses, payments, or a combination thereof.

14. An apparatus according to claim 12, wherein the apparatus is further caused to:
determine density information associated with the payment activity and other payment activities, wherein the depiction of the economic activity is further based on the density information.

15. An apparatus according to claim 12, wherein the apparatus is further caused to:
determine a customer base, a potential customer base, or a combination thereof of the region based on the association, wherein the map further depicts the customer base, the potential customer base, or a combination thereof.

16. An apparatus according to claim 11, wherein the apparatus is further caused to:
forecast a market value relating to the location, other locations, or a combination thereof based on the association.

17. A system comprising:
one or more processors configured to execute a tracking module and a cross-marketing module,
wherein the tracking module is configured to track a purchase-related action of a user performed at a first store, and
wherein the cross-marketing module is configured to determine a second store within proximity of the first store based on the tracked purchase-related action, and generate, in real-time with respect to the purchase-related action performed at the first store, an offer relating to the second store for the user.

18. A system according to claim 17, further comprising a payment activity module configured to:
determine payment activity relating to the purchase-related action; and
associate the payment activity with the first store, a location of the first store, or a combination thereof.

19. A system according to claim 17, wherein the payment activity module is further configured to:
generate a map depicting economic activity of a region based on the association, wherein the depiction of the economic activity includes a representation of consumers, businesses, payments, or a combination thereof.

20. A system according to claim 17, wherein the payment activity module is further configured to:
determine density information associated with the payment activity and other payment activities, wherein the depiction of the economic activity is further based on the density information.
